(19) United States
(12) Patent Application Publication
(10) Pub. No.: US 2009/0070980 A1
(43) Pub. Date: Mar. 19, 2009

(54) System for servicing machine track and method

(76) Inventor: Richard E. Livesay, Peoria, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/901,796

(22) Filed: Sep. 19, 2007

(51) Int. Cl. B23P 19/00; B25B 27/00

(52) U.S. Cl. 29/426.5; 29/281.5

(57) ABSTRACT

A system for servicing machine track includes a press having a housing and a reaction bolster coupled therewith, and first and second tool support plates. A first service tool set for assembling track links onto track pins is configured to couple with the first and second tool support plates. A second service tool set for disassembling track links from track pins is configured to couple with the first and second tool support plates. In a first assembly configuration, the system is adapted to field service a first type of machine track, whereas in a second assembly configuration the system is adapted to field service a different type of machine track.

### TECHNICAL FIELD

The present disclosure relates generally to systems for assembling and disassembling machine track, and relates more particularly to such a system having a service tool kit for adapting it to service different types of machine track.

### BACKGROUND

A variety of different types of machines utilize tracks, as ground engaging elements to propel the machine or for other purposes such as conveying or as torque transmitting devices. Many machine tracks are subjected to substantial wear and tear during operation. Track links or track pins may break, seals may fail, or parts of the track may simply become so worn that they need servicing or replacing. Due to the robust nature of many machine track designs, they can require relatively rugged and/or powerful tools for servicing, making assembly and disassembly relatively involved tasks. Moreover, in many instances it is desirable to service a machine track in the field, rather than transporting the machine to a service center, to minimize downtime and repair expense.

One means for easing track disassembly and assembly, and hence servicing, is through the use of master links. Master links are intended to provide a relatively easier means for “breaking” a track than would otherwise be available. Master links have been in widespread use for some time. However, since they typically only allow breaking of a track at one location, they do not adequately provide for servicing of the entire track, and traditional assembly and/or disassembly techniques are still often required. Moreover, the design of some tracks makes developing suitable master links difficult.

Servicing certain types of track, particularly some tracks used on track-type machines such as tractors, may be done with a field service press. Field service presses are typically relatively bulky, heavy and unwieldy, as well as expensive. They have nevertheless proven indispensable to equipment dealers and service technicians tasked with repairing machine tracks in the field. A typical field service press includes a hydraulic ram which can press track pins out of track chains to allow disassembly at any desired location. While these systems have proven effective in many environments, there is always room for improvement. Moreover, traditional field service presses tend to be poorly suited for servicing certain modern track designs.

In recent years, engineers have proposed a variety of track service tools intended to alleviate some of the shortcomings associated with earlier systems. U.S. Pat. No. 6,951,096 to Maguire et al. discloses one example of an apparatus for servicing track. The Maguire et al. system is portable, and uses a set of contact tools and an assembly tool, in conjunction with positioning blocks, to press outer track links onto track pins. While Maguire et al. appear to provide a number of advantages over other portable track servicing systems, there is always room for improvement.

The present disclosure is directed to one or more of the problems or shortcomings set forth above.

### SUMMARY OF THE DISCLOSURE

In one aspect, the present disclosure provides a system for servicing machine track which includes a press having a housing, a reaction bolster coupled with the housing and a rod movable relative to the housing from a first position to an extended position. The system further includes a first tool support plate and a second tool support plate, each having an inboard side configured for mounting track service tools thereon, and an outboard side configured to couple with one of the reaction bolster and the rod. The system further includes a first service tool set having at least one track contact tool for assembling track links onto track pins by extending the rod relative to the housing and being configured to couple with the inboard side of at least one of the tool support plates. The system still further includes a second service tool set having at least one track contact tool for disassembling track links from track pins by extending the rod relative to the housing and being configured to couple with the inboard side of at least one of the tool support plates.

In another aspect, the present disclosure provides a kit for adapting a field service press having a housing, a movable rod and a reaction bolster, for servicing straight link machine track. The kit includes a first tool support plate and a second tool support plate, each having an inboard side configured for mounting track service tools thereon and an outboard side configured for coupling with one of the reaction bolster and the movable rod of the press. The kit further includes a first service tool set having at least one track contact tool for assembling track links onto track pins via actuation of the press and being configured to couple with the inboard side of at least one of the tool support plates. The kit still further includes a second service tool set having at least one track contact tool for disassembling track links from track pins via actuation of the press and being configured to couple with the inboard side of at least one of the tool support plates.

In still another aspect, the present disclosure provides a method of field servicing a machine track with a press having a housing, a reaction bolster coupled with the housing and a rod movable relative to the housing. The method includes a step of determining whether the machine track is of a first type or of a second type different from the first type. The method further includes, if the machine track is of a first type, servicing the track by using the press with a service tool set having a tool support plate mounted on the rod and coupled with at least one track contact tool which is adapted to press an outboard link of the track off of track pins via actuation of the press. The method still further includes, if the machine track is of a second type, servicing the track by using the press without the service tool set.

### BRIEF DESCRIPTION OF THE DRAWINGS

FIG. 1 is a pictorial view of a system for servicing machine track according to one embodiment, in a first assembly configuration;

FIG. 2 is a pictorial view of a system for servicing machine track according to one embodiment, in another assembly configuration;

FIG. 3 is a top view of the system of FIG. 2 positioned about a machine track;

FIG. 4 is a pictorial view of a system for servicing machine track, in yet another assembly configuration;

FIG. 5 is a top view of the system of FIG. 4 positioned about a machine track;

FIG. 6 is an exploded view of a system for servicing machine track according to one embodiment;

FIG. 7 is a side diagrammatic view of a portion of the system of FIG. 6; and

FIG. 8 is a sectioned view taken along line 8-8 of FIG. 7.

### DETAILED DESCRIPTION

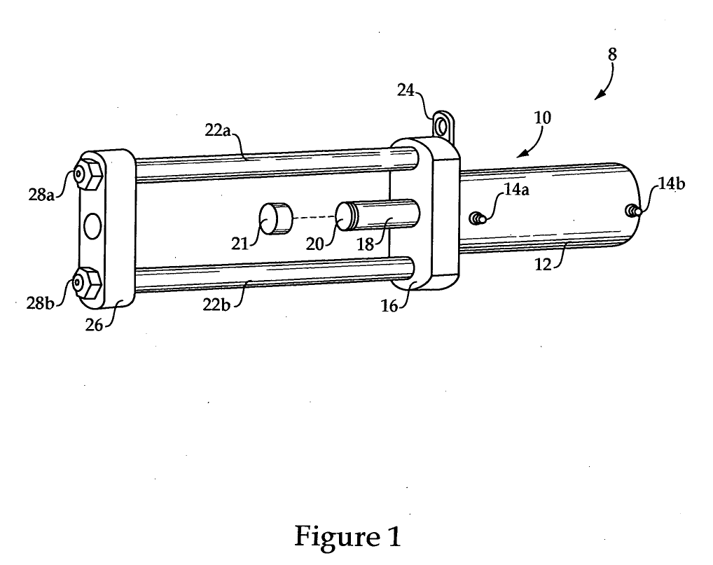

Referring to FIG. 1, there is shown a system 8 for servicing machine track. In one embodiment, system 8 may comprise a field service press 10 of the type commonly used to assemble and disassemble machine track in the field, such as machine track commonly used in connection with track-type tractors and the like. In other embodiments, however, system 8 might be employed in the context of track servicing at a service center, or even for initial track assembly and testing, etc. Press 10 may include a housing 12 having an end plate 16 and a rod 18 movable from a first position to an extended position relative to housing 12. Press 10 may be a hydraulic press having a first inlet/outlet port 14a and a second inlet/outlet port 14b. A lifting eye 24 may be attached to end plate 16 for supporting and positioning press 10 via a crane, hoist or other lift device mounted on a service truck or the like. Press 10 may further include a reaction bolster 26 positioned opposite housing end plate 16 and coupled therewith via first and second connecting rods 22a and 22b, respectively. Each of connecting rods 22a and 22b may be coupled with reaction bolster 26 via nuts 28a and 28b, respectively.

In the FIG. 1 illustration, system 8 is shown in an assembly configuration contemplated to be suitable for servicing a first type of machine track. Rod 18 may include an end face 20, and in some embodiments may include an end cap 21 which is threaded onto an end of rod 18. When moved from a first position, approximately as shown, to a second position relative to housing 12, rod 18 may press track pins out of track links to disassemble the corresponding track. In one embodiment, the assembly configuration shown in FIG. 1 may be used for servicing track having S-shaped track links, and may further be used to press track pins back into track links to reassemble a particular portion of the track upon concluding servicing. As further described herein, service tools in the form of a kit may be used to adapt system 8 to other assembly configurations for servicing different types of track, such as track having straight links.

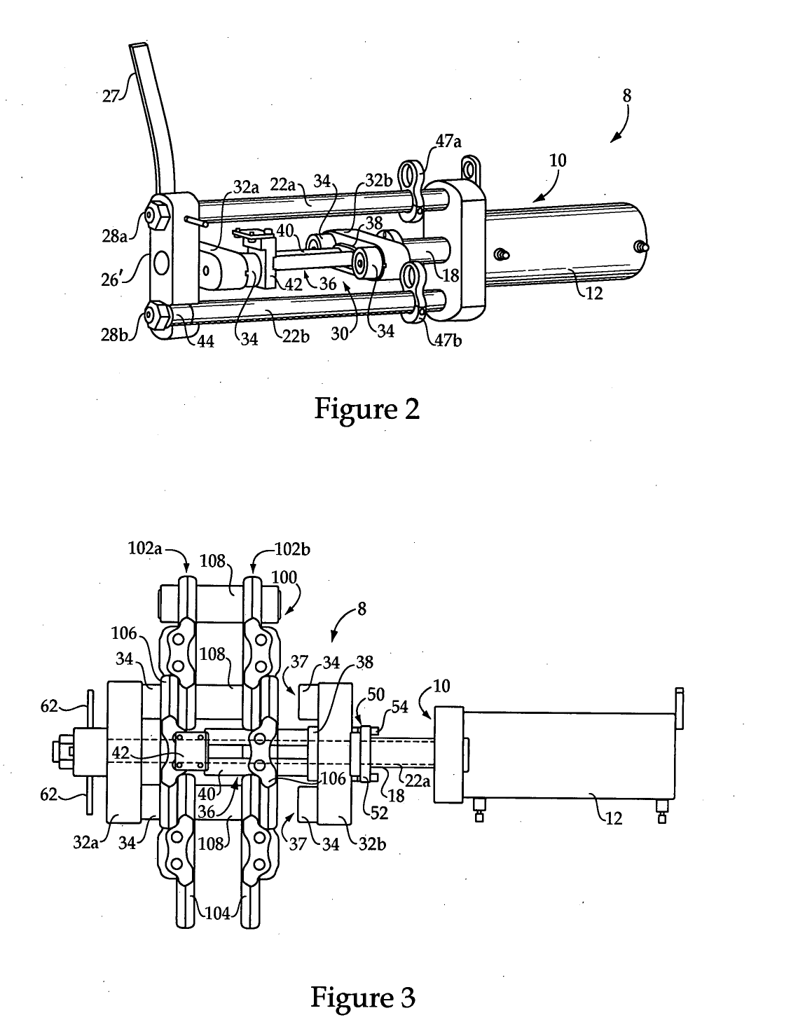

Turning now to FIG. 2, there is shown system 8 in a second assembly configuration wherein a set of service tools 30 is coupled with press 10. In the embodiment shown, service tools 30 may be used for disassembling a machine track such as a track having straight links via extension of rod 18 from its first position toward its second, extended position relative to housing 12. In particular, service tool set 30 may include at least one track contact tool 36 which is configured to be positioned against an inboard side of an outboard track link as described herein to press the outboard track link simultaneously off of two track pins. Contact tool 36 may comprise a disassembly tool having a link plate 42, one or more support pins 40 and a support element 38. Support element 38 is configured to mount to a tool support plate 32b which is positioned on rod 18, and also configured to separately mount to another tool support plate 32a which is positioned on a reaction bolster 26′. In the embodiment shown, reaction bolster 26′ is different from reaction bolster 26 shown in FIG. 1, and has certain advantages with regard thereto as further described hereinbelow. It should be understood, however, that either reaction bolster illustrated herein, or other reactions bolsters not shown might also be used. Service tool set 30 may further include a set of pins 34, which are positionable two upon each of tool support plates 32a and 32b.

An additional lifting eye 47a is shown in FIG. 2, coupled with rod 22a, and can facilitate supporting system 8 in a desired orientation via a crane, lift, etc. Eye 47a may be used to accommodate the relatively different center of gravity of system 8 when in the assembly configuration shown in FIG. 2, as compared to the assembly configuration shown in FIG. 1. Yet another lifting eye 47b may be positioned on rod 22b. Each of the lifting eyes may couple with a chain and hook or the like. Where working track which is at an angle, chains supporting system 8 via eyes 47a, 47b, 24 may be attached or adjusted to allow rotation of press 10, bringing the appropriate service tools, described herein, into appropriate orientations with regard to the track to be worked. Where track to be serviced is generally parallel the ground, not at an angle, lifting eye 47b might not be used, and one or both of lifting eyes 47a and 24 can be used to support system 8 in a desired orientation, depending upon the center of gravity, which varies depending upon the particular assembly configuration of system 8, as further described herein. A design for eyes 47a and 47b is shown which includes a locking bolt at the side of the eye, allowing the lower straps of the eyes to be relatively thin and radiused to provide for easy access to service tooling of system 8.

As mentioned above, bolster 26′ shown in FIG. 2 differs from bolster 26 shown in FIG. 1, and may consist of a substitute reaction bolster which is part of a kit described herein, appropriate for use with system 8 in any of its assembly configurations. In one embodiment, reaction bolster 26′ may include a first bore (not visible) which receives first connecting rod 22a and a second bore, consisting of a partially open bore 46, which receives second connecting rod 22b. The portion of reaction bolster 26′ wherein bore 46 is disposed may be likened to a hook in some embodiments. A retention element 46, for example consisting of a lock ring positionable over connecting rod 22b and secured in reaction bolster 26′ via nut 28b, may be further provided. Retention element 44 may have a locking configuration such as that shown in FIG. 2 wherein connecting rod 22b cannot be removed readily from bore 46. Retention element 44 may have a second, unlocked configuration, for example when nut 28b is loosened, at which connecting rod 22b can be removed from bore 46 without removing connecting rod 22a from its corresponding bore in reaction bolster 26′.

A lever arm 27 is provided which may be coupled with reaction bolster 26′ to enable rotating reaction bolster 26′ on connecting rod 22a when it is decoupled from connecting rod 22b. In one embodiment, lever arm 27 may be angled as shown, whereas in other embodiments it might comprise a straight bar. In either case, lever arm 27 may be fitted onto lifting pegs 62 which are configured to facilitate lifting and positioning of bolster 26 and coupled therewith. By rotating reaction bolster 26′ system 8 may be easily positioned such that a section of machine track lies within an enclosed frame comprised of housing 12, connecting rods 22a and 22b and reaction bolster 26′, without completely decoupling reaction bolster 26′ from the other components of system 8. In other words, with reaction bolster 26′ rotated out of the way, connecting rods 22a and 22b may be positioned one above, and one below, a section of machine track for servicing, then reaction bolster 26′ may be coupled with connecting rod 22b by securing retention element 44 therewith via nut 28b. In one embodiment, retention element 44 may comprise a lock ring having an outer diameter sufficiently large to inhibit removing of connecting rod 22b from bore 46 by rotating reaction bolster 26′ when retention element 44 is within bore 46. Since reaction bolsters of the type used with field service presses tend to be relatively heavy, the present strategy provides advantages over known systems in that it is no longer necessary for a technician to remove a reaction bolster from each of its associated connecting rods, position the system about a section of track, then manually replace the reaction bolster. The bolster design described herein also improves the speed with which system 8 can be positioned and/or repositioned for track servicing as compared with earlier designs.

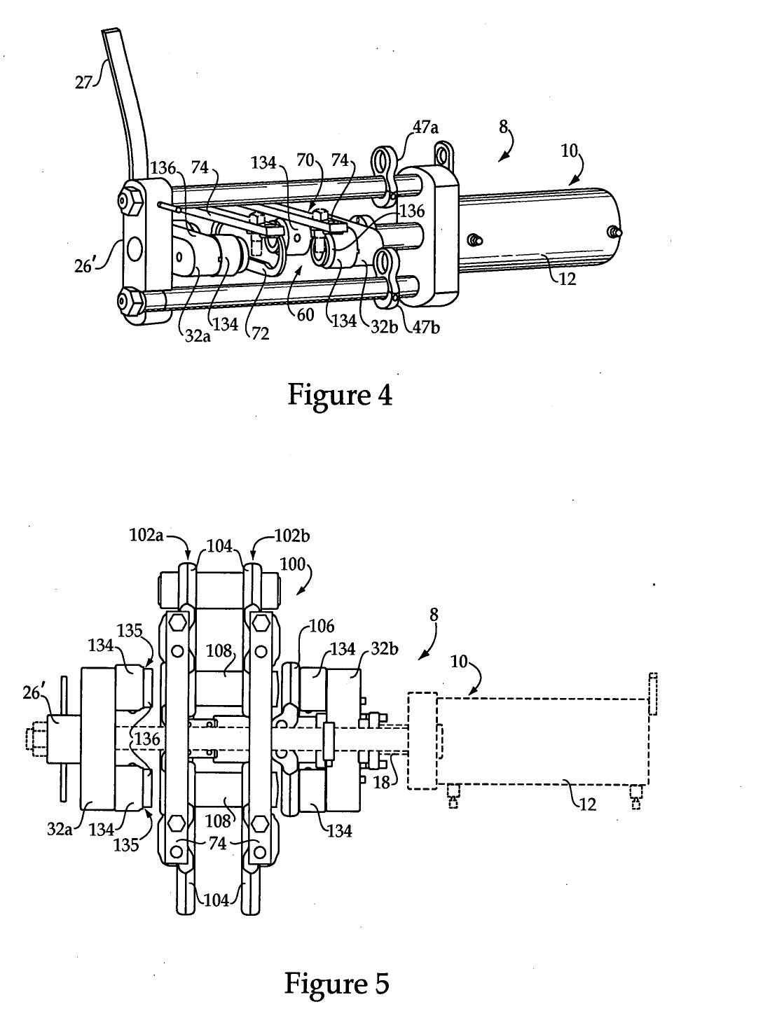

Turning now to FIG. 4, there is shown system 8 in yet another assembly configuration, wherein it is adapted for assembling a section of machine track such as track having straight links. In the assembly configuration shown in FIG. 4, a different service tool set 60 comprising an assembly service tool set may be coupled with tool support plates 32a and 32b. Service tool set 60 may include a set of track contact disks 134, each of which includes a reciprocable plunger 136 configured to support a track link thereon during pressing the track link simultaneously onto two track pins. Also shown in FIG. 4 is a track support assembly 70 which includes an alignment or “dummy” link 72 and a set of nut bars 74. In one embodiment, alignment link 72 may be used to support or locate track components in desired assembly positions, whereas each of nut bars 74 may be coupled with track links adjacent the section of track into which two track links are to be assembled, as further described herein. It should be appreciated that any of a variety of means might be used to support or locate track components for assembling via service tool set 60, and track support assembly 70 is shown herein purely for illustrative purposes.

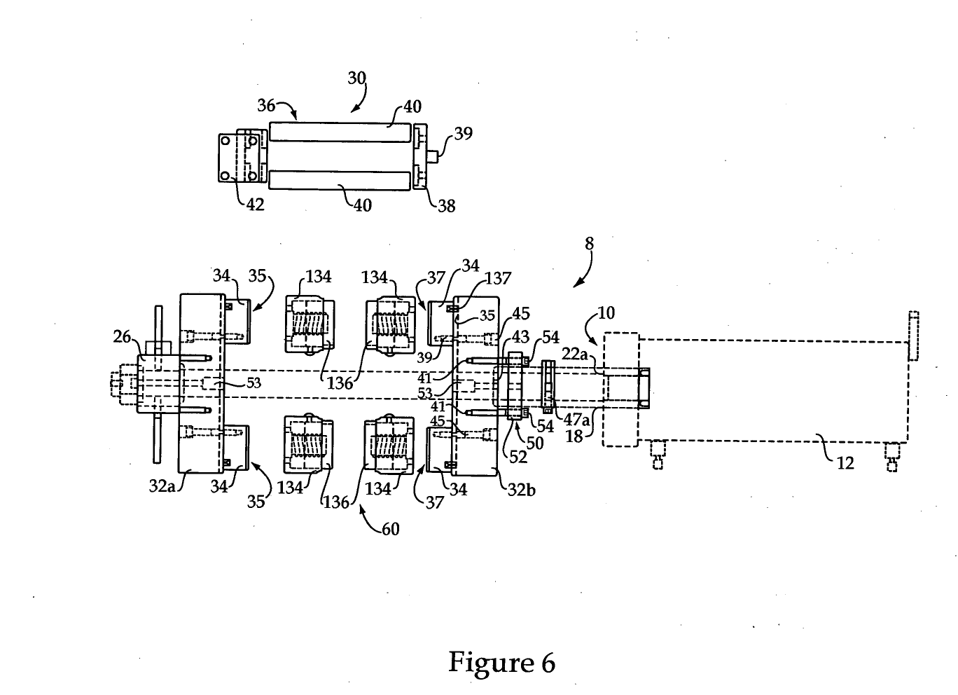

Referring now to FIG. 6, there is shown an exploded view of various of the components of system 8 illustrating certain of the features in more detail. As illustrated, service tool set 30 may include several sub-components, including link plate 42, support pins 40 and support element 38, which may be coupled together into track contact tool 36. A mounting element such as an extension 39 may be formed on or coupled with support element 38 to enable mounting of track contact tool 36 to either of tool support plates 32a and 32b, for disassembling a track link from first and second track chains, respectively, of a machine track. To this end, each tool support plate 32a, 32b may include a mounting element such as a bore 53 which is configured to receive extension 39. An opposite configuration where tool support plates 32a and 32b include an extension, and support element 38 has a bore, or some other design would be possible within the context of the present disclosure. Fasteners, or some other coupling strategy, may be used to locate and support track contact tool 36 during use, for example, a bolt may be passed through support element 38 to engage in a counter bore 59 in plate 32b. Each tool support plate 32a, 32b may further include a bore 43 formed in a side opposite to that of bore 53. In one embodiment, rod 18 or cap 21 may extend at least partially into bore 43 of tool support plate 32b, serving to position tool support plate 32b at a desired location and/or orientation relative to rod 18, for example centering tool support plate 32b thereon, as described herein.

A mounting assembly 50 which includes a ring 52 positionable about rod 18 and a plurality of fasteners 54 may be provided for securing tool support plate 32b to rod 18, and assisting in centering it thereon. End cap 21 may be used as described above, and may be threaded onto rod 18 and positionable within bore 43. In one embodiment, tool support plates 32a and 32b may be identical, such that either may be coupled with bolster 26′ or rod 18. In other embodiments, the respective tool support plates might be specific to the components to which they mount. The present description of tool support plate 32b should therefore be understood to also refer to and describe features common with tool support plate 32a. Tool support plate 32b may further include another set of bores 41 which are configured to receive fasteners 54. In one embodiment, ring 52 may rotate about rod 18 when tool support plate 32b is coupled therewith to allow rotation between tool support plate 32b and rod 18, as described herein.

Also shown in FIG. 6 are the set of pins 34, which are coupled two with each of tool support plates 32a and 32b. Pins 34 may be positioned to react loads on track links being pressed off of a track by positioning contact faces 37 of each of pins 34 against the ends of track pins which extend within the subject track links, as further described herein. Each of tool support plates 32a and 32b may further include mounting elements for engaging with pins 34. In one embodiment, each of pins 34 may include a first mounting element 137, such as a stub pin, which is positionable within a slot 35 in the corresponding tool support plate 32a, 32b. Each of pins 34 may further include a bore 39 which is configured to register with another bore in tool support plate 32b, through which a fastener 45 can extend to engage with pin 34. Also shown in FIG. 6 are a set of contact disks 134 of service tool set 60, adapted for assembling track links onto track pins. Each of contact disks 134 may include a reciprocable plunger 136 which is configured to support a track link thereon during pressing the track link onto track pins via contact disks 134, as further described herein.

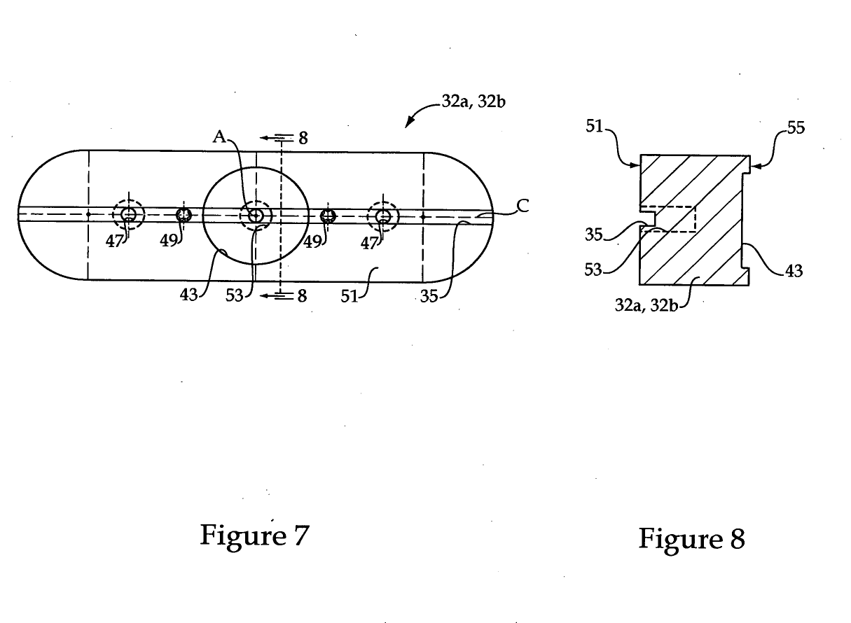

Turning now to FIGS. 7 and 8, there are shown illustrations representing either of tool support plates 32a or 32b. An inboard side 51 of tool support plate 32a, 32b is shown. It may be noted that slot 35 may extend along an entirety of the length of inboard side 51. Bore 43 is shown located in outboard side 55 of tool support plate 32a, 32b. As used herein, inboard means the side of tool support plates 32a and 32b, to which service tool sets 30 and 60 mount, whereas outboard is the opposite side. It may further be noted that each of bores 47, 49, 43 and 53 is generally centered on a centerline C of slot 35. A center point A of tool support plate 32a, 32b corresponds with a longitudinal center axis of rod 18 when tool support plate 32a, 32b is coupled therewith. Bore 43 may thus be configured to center tool support plate 32a, 32b on rod 18 such that point A intersects with the center axis of rod 18. The arrangement of bore 47 and bore 43 and slot 35 represents one of many possible patterns of mounting elements which can allow pins 34 and contact disks 134 to be positioned on tool support plates 32a and 32b. By arranging these, or different, mounting elements of tool support plate 32a, 32b in a predetermined pattern, either of service tool sets 30 or 60 may be coupled thereon and automatically positioned appropriately. Other mounting configurations are of course possible which would achieve a similar goal.

In some instances, at least a portion of the components of system 8 will be configured for servicing a specific size of track. Machine track is often characterized as having a particular “pitch,” which may be defined as a distance between longitudinal centers of adjacent bores in the track links. Thus, track with a longer pitch typically has longer track links. Tool support plates 32a and 32b may be sized such that track having a certain pitch or range of pitches may be serviced thereby. To accommodate servicing track of different sizes, system 8 could be equipped with different sized tool support plates such that service tool sets 30 and 60 may be mounted on tool support plates which are sized and configured according to the pitch of the particular track. In a practical implementation strategy, however, a given set of two tool support plates may be used to service track having a range of pitches. Where mounting elements such as stub pin 137 are used, a bolt, etc. may be positioned in bore 47, and the stub pin placed in slot 35 at any of a range of positions corresponding to a size of the service tool, i.e. pin or contact disk, which is used. In other words, pins such as pins 34, and contact disks 134, having different sizes corresponding to a range of track pitches may be accommodated by tool support plates 32a and 32b, as the mounting elements thereof may be universal to a range of service tool sizes.

In a related vein, the suitability of contact disks 134 for pressing track links onto a section of track may depend in part on the diameter thereof. Larger tracks typically have larger bores in their track links to accommodate larger track pins, hence, contact disks 134 may have outer diameters larger than the bores in the subject track links, as contact faces 135 of contact disks 134 need to be able to bear against an outboard side of track links during pressing them onto track pins. Pins 34 may similarly need to be of a certain size, as track links pressed off of track pins via service tool set 30 may be pushed onto pins 34 when removed from track pins of the track. In either case, system 8 and/or a kit for adapting system 8 to service a particular type or size of machine track may include multiple sets of identical contact disks, each set having a size contemplated to be appropriate for working a particular size of track. For example, the four contact disks 134 shown in FIG. 6 might be a first set for a first size of straight link track. A second set of four contact disks identical to those shown in FIG. 6, albeit larger, might be provided for servicing the next size up of the same type of track. Sets of different sized pins, in addition to pins 34, might also be provided in some instances.

### INDUSTRIAL APPLICABILITY

Referring to the drawings generally, when track servicing is desirable, a technician will first typically determine whether the track is of a type appropriate for servicing via system 8 when in the configuration shown in FIG. 1, or of a different type appropriate for servicing via system 8 when in one of the other configurations described herein. Service tool sets 30 and 60 may be provided in the form of one or more kits which can be used to adapt system 8 for servicing at least two different types of machine track. If the track is of the latter type, commonly a straight link track, the technician may select service tool set 30 and couple the appropriate components to press 10. In particular, tool support plates 32a and 32b may be mounted on bolster 26′ and rod 18, respectively, and pins 34 may be mounted on tool support plates 32a and 32b. Pins 34 may be mounted to tool support plates 32a and 32b by placing elements 137 within slot 35 and securing fasteners 45 therewith. In other embodiments, some other mounting/coupling strategy might be used. With service tool set 30 coupled therewith, press 10 may be positioned about the section of track to be serviced. Where a rotatable bolster such as bolster 26′ is used, it may be rotated out of engagement with connecting rod 22b, and connecting rods 22a and 22b positioned one above, and the other below, the section of track to be serviced. Bolster 26′ may then be secured to connecting rod 22b. It should be appreciated that service tool set 30 might be mounted on tool support plates 32a and 32b after positioning press 12 about the section of track to be serviced in certain embodiments.

Once system 8 is positioned appropriately about the section of track to be serviced, track contact tool 36 may be coupled with one of tool support plates 32a and 32b. In one embodiment, the configuration of track contact tool 36 is such that it may be passed through open “windows” located between straps of the track links in the section of track to be serviced. Referring in particular to FIG. 3, there is shown system 8 in an assembly configuration appropriate for disassembling a section of straight link machine track 100. Track 100 includes a first track chain 102a and a second track chain 102b, each including inboard links 104 alternating with outboard links 106. Support pins 40 of track contact tool 36 extend through windows in an outboard link 106 of track chain 102b, and link plate 42 is positioned against an inboard side of an opposite outboard link 106 of track chain 102a, which is to be removed. Press 10 may then be actuated to extend rod 18 toward its extended position, pressing the subject outboard track link 106 simultaneously off of two track pins 108 of track 100. Pins 34, not to be confused with track pins 108, are positioned on tool support plate 32a such that their contact faces 37 bear against track pins 108 during pressing the subject outboard track link 106 off of track 100. Pins 34 can thus react the load from actuating press 10 applied via track contact tool 36. Moreover, pins 34 may be positioned during track disassembly such that the pressed-off track link 106 will be pushed onto pins 34, which can then support the track link by engagement of pins 34 within the bores of the front and back link straps of the track link.

Once an outboard track link from track chain 102a is disassembled from track 100, it may be removed from pins 34 and track contact tool 36 may be decoupled from tool support plate 32a, then mounted to the opposite tool support plate 32b. The described process may be repeated for track chain 102b, also by extending press 10, and pressing the opposite outboard track link 106 from track chain 102b. In some instances, it may be desirable to inhibit separation of adjacent pins 108 when pressing off a second outboard link 106. In other words, after an outboard link 106 is pressed off a first one of track chains 102a, 102b, it may be desirable to maintain an alignment of the associated track pins 108 during pressing off an opposite outboard link 106. A “dummy” link such as alignment link 72 may be used for this purpose, and may be positioned about ends of track pins 108 opposite to the second outboard link 106 which is to be removed.

After pressing one or more of links 106 off of track 100, it may be serviced, such as by replacing, lubricating, etc. one or more of track pins 108, replacing or servicing track links 106 or 104. Track 100 might also be decoupled from an associated machine for transport, servicing, replacement, etc. Inboard track links 104 may not be press fit with pins 108 in some embodiments and may therefore be slipped off. In embodiments where inboard links 104 are press-fit with pins 108, system 8 may be used in a manner similar to that described with regard to outboard links 106 to disassemble inboard links 104 from track 100. When a technician is prepared to reassemble track 100, service tool set 30 may be decoupled from system 8, and service tool set 60 coupled therewith.

In one embodiment, pins 34 may be swapped with contact disks 134, by decoupling pins 34 from tool support plates 32a and 32b and mounting contact disks 134 thereon. Contact disks 134 may have mounting elements similar or identical to those of pins 34 to enable them to mount to tool support plates 32a and 32b in a manner more or less identical to that of pins 34. Pins 34 and contact disks 134 will typically be cylindrical but could have different configurations in other embodiments. In any event, once contact disks 134 are mounted on tool support plates 32a and 32b, and press 10 is appropriately positioned, track support assembly 70, or another suitable support assembly, may be coupled with track 100 in preparation for assembly.

As mentioned above, nut bars 74 may be bolted or otherwise coupled with track links 104 on either side of a portion of track 100 to which links 106 are to be assembled. With nut bars 74 coupled each with two inboard track links 104 of track chains 102a and 102b, track pins 108 may be maintained in position via alignment link 72 in a manner similar to that used during track disassembly. Next, an outboard link 106 to be installed can be positioned on plungers 136 of contact disks 134, on an appropriate one of tool support plates 32a, 32b. Press 10 may then be actuated, to press the subject link 106 simultaneously onto two of track pins 108. If desired, a second link might be mounted on the opposite set of contact disks 134, such that two track links 106 are simultaneously pressed onto track 100. As mentioned above, the track links 106 being pressed on may be supported on plungers 136. Each of contact disks 134 may include a contact face 135 which has a diameter larger than the pin-receiving bores in track links 106. This enables contact faces 135 to bear against the track links 106 during actuation of press 10. As assembly of a given track link 106 progresses, plungers 136 will tend to bear against ends of track pins 108. Since plungers 136 are typically spring-loaded, they will tend to retract into contact disks 134 as the subject track link 106 is pressed onto track pins 108. Eventually, plungers 135 may be fully retracted into contact disks 134 approximately at the point at which links 106 are pressed on to desired positions on track pins 108. The process may then be repeated for the other track chain, if necessary.

The present disclosure offers numerous advantages over previous track servicing systems. On the one hand, track service presses of the type widely used in the industry tend to be relatively expensive. They are also relatively bulky, slow, sometimes unwieldy and not readily used to service more than one type of track. The present disclosure sets forth a manner of adapting certain existing presses such that they can be used more efficiently, for example via the improved reaction bolster design set forth herein, as well as making existing presses capable of servicing more than one type of track. The present system 8 can effectively make all outboard track links operate as master links, allowing track disassembly at any location. A great many track service tools have been proposed over the years to accommodate the evolving needs of track technicians, due to changes in track design as well as the demand for improvements in portability, performance, etc. Many of these newer service strategies, however, require investment in an entirely new type of system, which is itself often very labor intensive to set up for operation. Moreover, it is common for a first type of service system to be used for disassembling track, while a second type of system is used for assembly. The present disclosure allows an existing system to continue to be used for servicing one type of track, while providing tools which adapt it to service a second type of track, for both assembly and disassembly. This flexibility is based in part on the use of tool support plates 32a and 32b which are capable of mounting either of disassembly tools, set 30, or assembly tools, set 60, therewith. Tool support plates 32a and 32b serve as a common base for either of service tool sets 30 or 60, and therefore allow a single system to be reconfigured in the field and used for servicing different types of track, without needing separate systems or drastically different tooling set-ups for assembly versus disassembly, as sets 30 and 60 can be readily swapped on tool support plates 32a and 32b. While the present description discusses a particular combination of mounting features on tool support plate 32a, 32b, in particular locations, it is emphasized that a wide variety of features and mounting strategies could be used for mounting service tool sets 30 and 60 on tool support plates 32a, 32b, including pins, keyed mating features, bolts, threaded engagement, etc., without departing from the intended scope of the present disclosure.

A still further advantage offered by the present disclosure is the ability to readily work on a section of track which is oriented diagonally relative to a vertical direction. In one embodiment, each of track contact tools 32a and 32b may be rotatably mounted one to each of reaction bolster 26′ and rod 18. During use, system 8 will typically be suspended from a lift, crane, hoist, etc. as described herein, such that connecting rods 22a and 22b will be positioned more or less in a vertical plane. By rotating each of track contact tools 32a and 32b, they may be positioned such that pins 34 are properly oriented to react loads via engaging against track pins, even where the associated track is oriented diagonally. Contact disks 134 may be similarly positioned in appropriate orientations for assembly by rotating tool support plates 32a, 32b.

The present description is for illustrative purposes only, and should not be construed to narrow the breadth of the present disclosure in any way. Thus, those skilled in the art will appreciate that various modification might be made to the presently disclosed embodiments without departing from the full and fair and scope and spirit of the present disclosure. For example, while each of service tool sets 30 and 60 may include a plurality of components which mount to each of tool support plates 32a and 32b, in other embodiments a lesser number of parts might be used. For instance, pins 34 might be formed integrally with or irreversibly mounted on a first set of tool support plates, whereas contact disks 134 could be integral with or irreversibly mounted on a second set of tool support plates. In such an embodiment, each service tool set could consist of two pieces. Other aspects, features and advantages will be apparent from an examination of the attached drawings and appended claims.

What is claimed is:

1. A system for servicing machine track comprising:
a press having a housing, a reaction bolster coupled with said housing and a rod movable relative to said housing from a first position to an extended position;
a first tool support plate and a second tool support plate, said tool support plates each having an inboard side configured for mounting track service tools thereon and an outboard side configured to couple with one of said reaction bolster and said rod;
a first service tool set comprising at least one track contact tool for assembling track links onto track pins by extending said rod relative to said housing and being configured to couple with the inboard side of at least one of said tool support plates; and
a second service tool set comprising at least one track contact tool for disassembling track links from track pins by extending said rod relative to said housing and being configured to couple with the inboard side of at least one of said tool support plates.

2. The system of claim 1 wherein said press is a field service press wherein said housing, said reaction bolster and a set of connecting rods coupling said housing with said reaction bolster comprise an enclosed frame for positioning about a machine track during servicing, and wherein said system has a first assembly configuration adapted for field servicing a first type of machine track and at least one other assembly configuration adapted for field servicing a different type of machine track.

3. The system of claim 2 wherein:
said rod comprises an end configured for pressing a track pin into or out of an S-shaped track link when said system is in said first assembly configuration;
the at least one track contact tool of said first service tool set comprises two contact faces positionable against an outboard side of a straight track link for pressing it onto two track pins when said system is in a second assembly configuration; and
the at least one track contact tool of said second service tool set comprises a disassembly tool having a link plate positionable against an inboard side of a straight track link for pressing it off of two track pins when said system is in a third assembly configuration.

4. The system of claim 2 wherein the at least one track contact tool of said first service tool set comprises at least two contact disks configured to couple with said first tool support plate and at least two other contact disks configured to couple with said second tool support plate, each of said contact disks including a reciprocable plunger adapted to locate a straight track link during pressing the straight track link onto two track pins.

5. The system of claim 4 wherein the at least one track contact tool of said first service tool set includes a first subset of identical contact disks adapted for servicing a first size of straight link machine track and a second subset of identical contact disks larger than said first subset and adapted for servicing a second size of straight link machine track.

6. The system of claim 2 wherein said second service tool set includes a disassembly tool having a support element configured to alternately couple with each of said first and second tool support plates and a link plate spaced from and coupled with said support element via at least one support pin and positionable against an inboard side of a straight track link for pressing it off of two track pins.

7. The system of claim 1 wherein said tool support plates rotatably couple one with each of said rod and said reaction bolster.

8. The system of claim 1 wherein:
said press further includes a first connecting rod and a second connecting rod coupling said reaction bolster with said housing;
said reaction bolster includes a first bore receiving said first connecting rod and a second, partially open bore receiving said second connecting rod; and
said system further comprises a retention mechanism coupled with said second connecting rod and having a release state at which said bolster can be decoupled from said second connecting rod without decoupling from said first connecting rod, and a locking state.

9. A kit for adapting a field service press having a housing, a movable rod and a reaction bolster, for servicing straight link machine track comprising:
a first tool support plate and a second tool support plate, said tool support plates each having an inboard side configured for mounting track service tools thereon and an outboard side configured for coupling with one of the reaction bolster and the movable rod of the press;
a first service tool set comprising at least one track contact tool for assembling track links onto track pins via actuation of the press and being configured to couple with the inboard side of at least one of said tool support plates; and
a second service tool set comprising at least one track contact tool for disassembling track links from track pins via actuation of the press and being configured to couple with the inboard side of at least one of said tool support plates.

10. The kit of claim 9 wherein said first tool support plate includes at least one bore in its outboard side, said kit further comprising a mounting assembly for said first tool support plate which includes a rod cap positionable within said at least one bore and configured to mount said first tool support plate on the rod.

11. The kit of claim 10 wherein said mounting assembly includes a support ring positionable about the rod and a plurality of fasteners configured to extend through said ring and engageable with said first tool support plate.

12. The kit of claim 10 wherein:
each of said tool support plates includes mounting elements on their inboard sides;
the at least one track contact tool of said first service tool set comprises a set of contact disks having mounting elements which correspond with mounting elements on the inboard sides of said tool support plates; and
the at least one track contact tool of said second service tool set comprises a set of pins also having mounting elements which correspond with mounting elements on the inboard sides of said tool support plates.

13. The kit of claim 9 wherein the at least one track contact tool of said first service tool set comprises a set of contact disks that includes a first subset of four identical disks for servicing a first size of straight link machine track and at least one other subset of four identical disks larger than the first subset for servicing a second size of straight link machine track.

14. The kit of claim 9 wherein the at least one track contact tool of said second service tool set comprises a disassembly tool having a support element configured to alternately couple with each of said first and second tool support plates and a link plate spaced from and coupled with said support element via at least one support pin.

15. The kit of claim 14 further comprising a substitute reaction bolster configured to substitute for the reaction bolster of the press which includes a first bore configured to receive a first connecting rod of the press and a second, partially open bore configured to receive a second connecting rod of the press, and a retention element configured to couple the second connecting rod within the second bore and having a release state and a locking state.

16. A method of field servicing a machine track with a press having a housing, a reaction bolster coupled with the housing and a rod movable relative to the housing, the method comprising the steps of:
determining whether the machine track is of a first type or of a second type different from the first type;
if the machine track is of a first type, servicing the track by using the press with a service tool set having a tool support plate mounted on the rod and coupled with at least one track contact tool which is adapted to press an outboard link of the track off of track pins via actuation of the press; and
if the machine track is of a second type, servicing the track by using the press without the service tool set.

17. The method of claim 16 wherein the step of servicing the track by using the press with a service tool set includes using the press with a service tool set having a first tool support plate rotatably mounted on the rod and a second tool support plate rotatably mounted on the reaction bolster of the press.

18. The method of claim 16 wherein the determining step includes determining whether the machine track is of a first type comprising S-shaped links or of a second type comprising straight links.

19. The method of claim 18 wherein the service tool set comprises a first set and the step of servicing the track by using the press with a service tool set comprises disassembling the track via the first service tool set, the method further comprising a step of reassembling the track with a second service tool set which includes four contact disks each having a contact face configured to press outboard links onto pins of the track.

20. The method of claim 19 wherein the step of servicing the track by using the press with the service tool set and the step of reassembling the track each include extending the rod of the press relative to the housing.
